(19) United States
(12) Patent Application Publication
(10) Pub. No.: US 2026/0257323 A1
(43) Pub. Date: Sep. 3, 2026

(54) SCREWING TOOL HAVING A TORQUE LIMITING DEVICE

(71) Applicant: Wera Werkzeuge GmbH, Wuppertal (DE)

(72) Inventor: Carsten SCHWARZER, Hückeswagen (DE)

(73) Assignee: Wera Werkzeuge GmbH, Wuppertal (DE)

(21) Appl. No.: 18/872,888

(22) PCT Filed: Jun. 1, 2023
(86) PCT No.: PCT/EP2023/064679

§ 371 Date: Dec. 9, 2024

(30) Foreign Application Priority Data
Jun. 10, 2022 (DE) 10 2022 114 689.8

(51) Int. Cl. B25B 23/142

(52) U.S. Cl. CPC B25B 23/1427

(57) ABSTRACT

A device has at least two torque transmission bodies which can be switched by means of a switching member into different operative positions in a torque transmission path between an input part and an output part. The torque transmission bodies are assigned torque limiting devices, by means of which only torques below another limit torque can be transmitted in the different operative positions.

### TECHNICAL FIELD

The invention pertains to a device for transmitting a torque from an input part to an output part, wherein a torque that is applied to the input part and transmitted to a first torque transmission body is in a first operative position only transmitted to the output part by means of a first torque limiting device if the torque lies below a first limit torque, and wherein a torque that is applied to the input part and transmitted to a second torque transmission body is in a second operative position only transmitted to the output part by means of a second torque limiting device if the torque lies below a second limit torque.

### PRIOR ART

DE 10 2018 112 068 A1 describes a device, by means of which torques that lie below two different limit torques can be transmitted from an input part to an output part. A pressure spring is supported on two torque transmission bodies that lie in a cavity of the input part in a rotationally fixed, but axially displaceable manner and respectively interact with a torque transmission body that is connected to the output part in a rotationally fixed manner by means of a torque limiting device. The torque limiting devices differ from one another in such a way that no torques above another limit torque can be transmitted from the input part to the output part.

Devices with similarly acting torque limiting devices are known from DE 10 2012 102 392 A1 or DE 10 2018 112 068 A1.

EP 2 155 438 B1 describes a pre-calibrated torque screwdriver with multiple torque transmission bodies that are arranged axially behind one another and respectively can be directly brought into a torque-transmitting operative connection with the output part such that different limit torques can be transmitted to a screw connection.

WO 99/04178 A1 describes a free-wheel engaging device with two outer rings of a free-wheel gear, which are arranged axially behind one another and respectively have rollers. A shaft can be selectively brought into an operative connection of the two outer free-wheel rings by means of an axial displacement. The shaft can be rotated either in the clockwise direction or in the counterclockwise direction.

EP 2594367 B1 discloses a screwing tool with the torque limiting device having three gear rims that are arranged on top of one another, wherein the central gear rim has teeth that protrude upward into an upper gear rim, as well as teeth that protrude downward into a lower gear rim.

DE 10341697 B3 discloses four gear rims that are acted upon by a single pressure spring, wherein two of said gear rims respectively mesh with one another. This design also does not allow an adjustment of two different torques because the two outer gear rims are connected to the handle in a rotationally fixed manner and the two inner gear rims are connected to the shaft in a rotationally fixed manner.

The initially described device in fact makes it possible to selectively tighten a screw connection with two different torques. However, a screwdriver bit has to be respectively inserted into another polygonal opening for this purpose.

### SUMMARY OF THE INVENTION

The invention is based on the objective of advantageously enhancing, in particular, a device known from WO 99/04178 A1 with respect to its use. The invention furthermore is based on the objective of enhancing a device, by means of which different limit torques can be transmitted from an input part to an output part, in such a way that more than two different limit torques can be selectively transmitted.

These objectives are attained with the invention specified in the claims, wherein the dependent claims not only represent advantageous enhancements of the invention specified in claim 1, but rather also independent solutions.

It is initially and essentially proposed that the torque can be selectively transmitted from the input part to the output part by different torque limiting devices, wherein each torque limiting device is assigned an individual limit torque. During the torque transmission, one torque transmission body interacts with another torque transmission body, wherein each torque transmission body forms part Of the torque limiting device. The torque transmission bodies can interact with a driver. It would be possible that a first torque transmission body interacts with a second torque transmission body by means of a torque limiting device. The second torque transmission body can interact with the driver. The torque transmission bodies preferably are designed and arranged in such a way that a torque exerted upon the first torque transmission body is transmitted to the second torque transmission body by means of a first torque limiting device. The torque exerted upon the second torque transmission body can be transmitted to a driver by means of a second torque limiting device. The second torque limiting device makes it possible to transmit a greater limit torque than the first torque limiting device. The driver may be connected to the output part in a rotationally fixed manner. The torque transmission bodies can then be selectively connected to the input part in a rotationally fixed manner. However, it is also possible to connect the driver to the input part in a rotationally fixed manner. In this case, the torque transmission bodies can be selectively connected to the output part in a rotationally fixed manner. According to the invention, a switching member is provided and makes it possible to selectively bring one of the torque transmission bodies into rotationally fixed relation with the input part or the output part depending on one of the above-described arrangements. The switching member may be a slide that can be displaced in the axial direction. The switching member may be arranged in a cavity, in which the torque transmission bodies are also arranged. In a preferred embodiment, at least two torque transmission bodies are arranged behind one another in the axial direction. The torque transmission bodies preferably are acted upon by a common spring element. In this context, a first torque transmission body that is directly acted upon by the spring element can transmit a first, lowest limit torque to a second torque transmission body. The second torque transmission body is coupled to another torque transmission body by means of a torque limiting device, wherein this torque limiting device has a greater limit torque. The second torque transmission body may be coupled to a third torque transmission body by means of a torque limiting device, wherein this torque limiting device once again has a higher limit torque. Consequently, a plurality of torque transmission bodies may be arranged axially behind one another, wherein the last torque transmission body is coupled to a driver by means of a torque limiting device that has the greatest limit torque. One of the torque transmission bodies can be selectively connected, for example to the input part, in a rotationally fixed manner by axially displacing the switching member. The limit torque that can be transmitted to the output part with the entire device then respectively corresponds to the lowest limit torque in the chain of torque limiting devices arranged in the torque transmission path. According to a preferred embodiment, the torque limiting devices are formed by torque transmission flanks. The torque transmission flanks may have a flank height that is measured in the axial direction. The torque transmission flanks may also have an angle of inclination that is measured in the circumferential direction. The flank height and/or the angle of inclination define the maximum limit torque, which can be transmitted by means of the abutting torque transmission flanks, together with the spring preload. A calibration of the limit torques therefore can be realized by means of the spring preload. When a torque is exerted upon a torque limiting device of this type, the oblique flank abutment of the torque transmission flanks results in an axial force that leads to an axial displacement of the torque transmission body being acted upon by the spring force when the spring preload, by means of which the device can be calibrated, is exceeded. The limit torque is reached when the torque transmission flanks, which preferably are realized in the form of teeth, are no longer engaged. The two torque transmission bodies can then rotate relative to one another. Consequently, the torque transmission device preferably is formed by axially interengaging toothings. The multiple torque transmission bodies arranged axially behind one another preferably are only coupled to one another axially by a mutual tooth engagement. They can axially yield against the restoring force of the spring element. The torque transmission bodies may be arranged axially behind one another and form a transmission chain that, starting from a minimum torque in a first switching position, also makes it possible to transmit greater torques in other switching positions, wherein the number of torque transmission bodies lying in the transmission chain is reduced as the switching positions are advanced. In another embodiment of the invention, multiple torque transmission bodies may not directly interact with one another, but each torque transmission body rather directly interacts with the output part and one of the multiple torque transmission bodies can be selectively coupled rotationally to the input part. A common spring that acts upon the torque transmission bodies in the axial direction may also be provided in this case, but such that interengaging torque transmission flanks interact in the axial direction. The torque transmission bodies may have coupling projections that extend radially outward and engage into coupling recesses of the switching member. The switching member preferably can have the shape of a sleeve with an inner wall that forms the coupling recesses. The coupling recesses may lie between two coupling projections. The torque-transmitting connection between switching member and torque transmission body may resemble a spline coupling. The switching member may be displaceable relative to the handle forming the input part in the axial direction. The handle may consist of one or more parts and forms a cavity, in which the switching member can be displaced. The switching member may have switching cams that protrude radially outward in order to constrain the switching member on the input part in a torque-transmitting manner. A torque can be transmitted to the switching cams. However, the switching member may also have projections that are designed differently and engage, for example, into a toothing formed on the inner wall of the cavity. Coupling recesses may be provided and the switching cam of the switching member can engage into said coupling recesses in its different switching positions. The recesses may start in the circumferential direction from a longitudinal slot that is arranged in the wall of the handle delimiting the cavity. The switching cam may slightly protrude beyond the outer surface of the handle such that it can be moved out of the latching recess, e.g. against a latching resistance, in order to be subsequently displaced in the longitudinal slot in the axial direction and thereby move the switching cam into another latching recess. The latching recesses may be realized in a comb-like manner. The device optionally is capable of transmitting torques in the counterclockwise direction, as well as in the clockwise direction. The toothings that forms the torque limiting device therefore may have symmetrical teeth. However, the toothings of the torque limiting devices may also have asymmetrical teeth such that different torques, e.g. greater torques, can be transmitted in the counterclockwise direction than in the clockwise direction. The handle may consist of multiple handle parts. A first handle part may form a bearing bore for a bearing section of the output part. A shaft of the output part may extend through the entire handle. A free end of the shaft may be supported in a bearing bore of an end face of the second handle part, wherein the two handle parts are rigidly connected to one another in the axial direction and the rotating directions by means of connecting elements. The output part may have an axial shaft with a round cross section. The torque transmission bodies may be rotatably supported on this shaft. It would be possible that each torque transmission body transmits a torque to a torque transmission body that is located directly adjacent to the torque transmission body in the direction of the driver. However, it would also be possible that output elements, which are connected to the shaft in a rotationally fixed manner, are provided between the torque transmission body, wherein the torque transmission body forms a torque limiting device with said output elements. These transmission bodies may be assigned to the shaft in a rotationally fixed, but axially displaceable manner.

### BRIEF DESCRIPTION OF THE DRAWINGS

An exemplary embodiment of the invention is described below with reference to the attached drawings. In these drawings:

FIG. 1 shows a perspective view of an exemplary embodiment of the invention,

FIG. 2 shows a view of the exemplary embodiment,

FIG. 3 shows a section along the line III-III in FIG. 2,

FIG. 4 shows a section along the line IV-IV in FIG. 3,

FIG. 5 shows a section similar to FIG. 3, in which a switching member 11 produces a rotation-inhibiting connection of a torque transmission body 3.1 on an input part 1,

FIG. 6 shows an illustration similar to FIG. 3, in which torque transmission flanks 4, 4′ of the torque transmission body 3.1 were moved out of a tooth engagement with torque transmission flanks 5, 5′ of a torque transmission body 3.2, which is located directly adjacent to the torque transmission body 3.1, due to a rotation of the input part 1 relative to the output part 2,

FIG. 7 shows an illustration according to FIG. 5, but in which the switching member 11 is axially displaced referred to an axis A in such a way that a torque transmission body 3.3 is moved into a torque-inhibiting connection with the input part 1 such that [text missing] can be transmitted to the output part 2 by means of the torque transmission body 3.3, a torque transmission body 3.4 located adjacent thereto and a driver 21 located adjacent to the latter,

FIG. 8 shows an illustration according to FIG. 6, but in which a torque applied to a torque limiting device consisting of the torque transmission flanks 4, 4′, 5, 5′ exceeds a limit torque such that the torque transmission flanks 4, 4′, 5, 5′ have been disengaged,

FIG. 9 shows an illustration according to FIG. 5, but in which the torque transmission body 3.4 produces a torque-transmitting connection with the input part 1 and the limit torque between the torque transmission flanks 4, 4′ and the torque transmission flanks 24, 24′ of the driver 21 has been exceeded such that the torque transmission flanks 4, 4′, 24, 24′ have been disengaged,

FIG. 10 shows an illustration according to FIG. 6, but in which the driver 21 is directly coupled to the input part 1 in a torque-transmitting manner due to an axial displacement of the switching member 11,

FIG. 11 shows an exploded view of the device,

FIG. 12 shows an illustration of the torque transmission body 3.4,

FIG. 13 shows an illustration of the torque transmission body 3.1 and

FIG. 14 shows an illustration of the switching member 11.

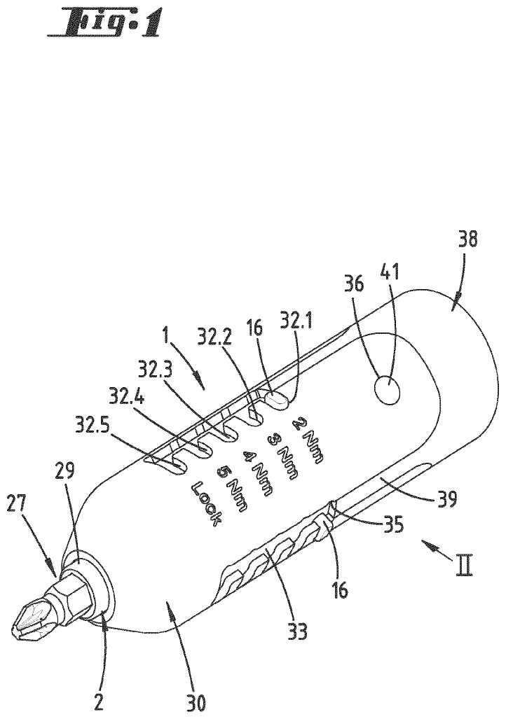

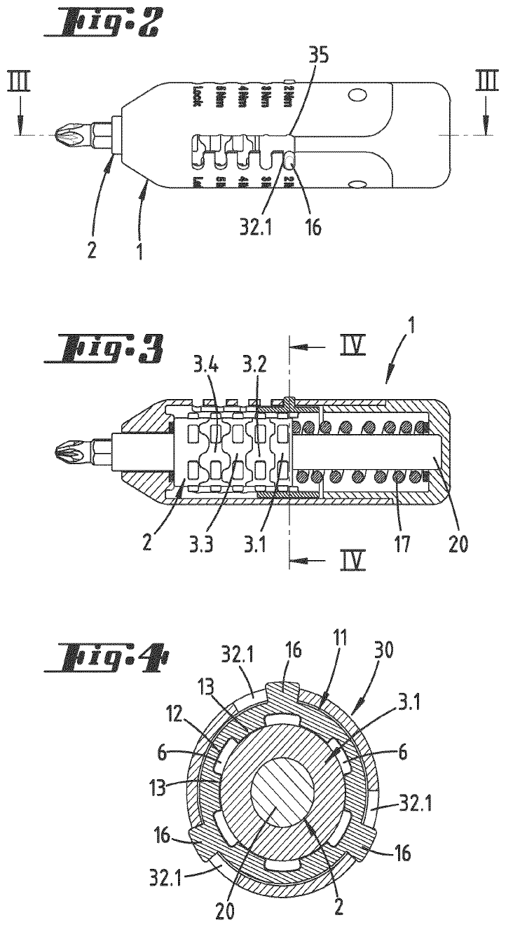

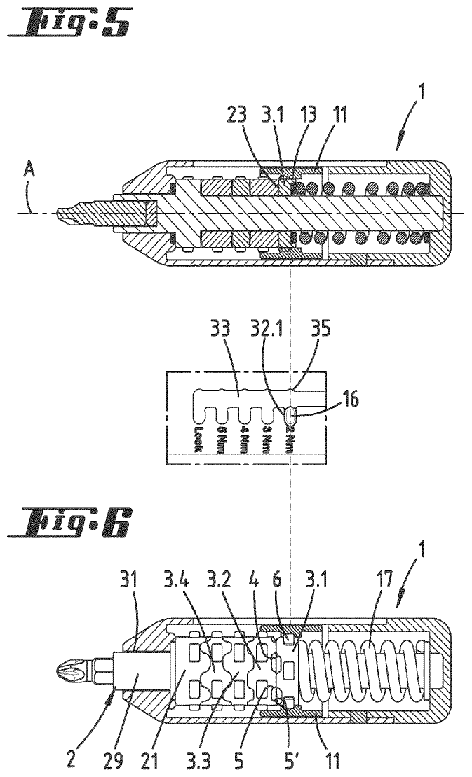

### DESCRIPTION OF THE EMBODIMENTS

The device illustrated in the drawings is a torque screwdriver in the form of an elongate screwdriver with an output part 2 having a polygonal opening 25, in which a magnet 26 is seated and into which a screwdriver bit 27 can be inserted. The output part 2 is seated in an input part 1 that is formed by an elongate handle extending coaxially to the output part 2. The handle consists of two handle parts 30, 38 that are interlocked in the axial direction. In the interlocked state, the two handle parts enclose a cavity 37, in which a multi-stage torque transmission gear is located.

The housing part 30 forms a bearing cavity 31, in which a bearing section 29 of the output part 2 is supported. The bearing section 29 is connected to a driver 21, which has a greater diameter than the bearing section 29, in a rotationally fixed manner. An end face of the driver 21 is supported on an end face of the cavity 37 with interposition of a washer 28. The driver 21 is followed by a circular-cylindrical shaft 20, the end of which lies in a bearing depression 42 of another housing part 38.

In the exemplary embodiment, the shaft 20 extends through the cavities 7 of a total of four torque transmission bodies 3.1, 3.2, 3.3, 3.4. A first torque transmission body 3.1 is directly acted upon by a helical pressure spring 17 with interposition of a washer 19, wherein said helical pressure spring is supported on the other end face of the cavity 37 with interposition of another washer 18. The spring element 17 is tensioned by applying an axial force during the assembly of the two handle parts 30, 38. A rear handle part 38 is pushed into the front handle part 30 during the assembly of the two handle parts, wherein ridges 39 engage into longitudinal slots 34 and close these longitudinal slots. In the exemplary embodiment, three sections f the two housings move into an overlapping position such that mounting openings 36, 40 are aligned with one another and connecting pin 21 can positively constrain the two handle parts 30, 38 on one another.

Preloading of the spring element 17 may alternatively also be realized with the aid of an abutment element that is fastened on the end of the shaft 20, wherein said abutment element is screwed on an external thread of the shaft 20, e.g. in the form of a nut.

The slot 34 continues in the form of a longitudinal slot 3 extending in the axial direction, wherein multiple recesses 32.1 32.2, 32.3, 32.4 and 32.5, which are spaced apart from one another in the axial direction, protrude from said longitudinal slot in the circumferential direction and form latching recesses. Latching indentations 35 lie opposite of the latching recesses 32.1 to 32.5 in the circumferential direction.

A switching member 11 formed by a sleeve extends in the cavity 37 and has a cavity that is surrounded by an inner wall 14. The switching member 11 has an outer wall 15 that extends on a cylinder surface, wherein the switching member 11 abuts on the inner wall of the cavity 37 in a displaceable manner with said outer wall. Cams 16 protrude from the outer wall 15 in uniform angular distribution. The preferably three cams 16 engage into the longitudinal slots 33 and can be selectively latched into one of the latching recesses 32.1 to 32.5 in the course of an axial displacement and a subsequent displacement in the circumferential direction, wherein the latching recesses have for this purpose latching projections in the region of their opening. It is therefore necessary to overcome a latching force in order to move the latching cam 16 into one of the latching recesses or out of one of the latching recesses.

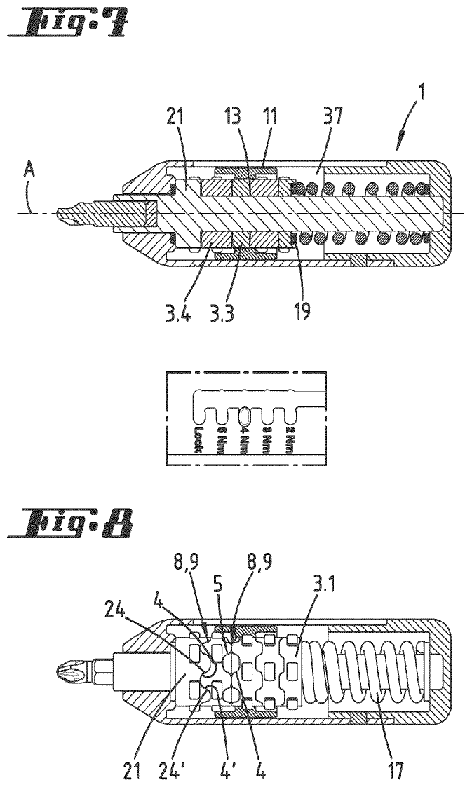

Additional torque transmission bodies 3.2, 3.3 and 3.4 lie between the driver 21 and the first torque transmission body 3.1. The torque transmission bodies are coupled to one another with torque limiting devices in such a way that a torque applied to the first torque transmission body 3.1 by means of the switching member 11 in the switching position illustrated in FIGS. 5 and 6 can be transmitted to the driver 21 when a torque is applied to the handle 30, 38.

In the switching position illustrated in FIGS. 5 and 6, the switching member is coupled to the first torque transmission body 3.1 in a rotationally fixed manner. This is achieved in that coupling projections 6, which radially protrude from the torque transmission body 3.1, engage into coupling recesses 12 that are arranged between two coupling projections 13 of the switching member 11. If the torque exerted upon the first torque transmission body 3.1 exceeds a first limit torque, the torque-transmitting connection between the first torque transmission body 3.1 and the second torque transmission body 3.2 is lost such that the rotationally fixed coupling between these two torque transmission bodies 3.1 and 3.2 is canceled.

The torque limiting device, by means of which the two torque transmission bodies 3.1 and 3.2 are coupled to one another, is formed by a toothing 23. The teeth of the toothing 23 form obliquely extending tooth flanks, wherein the tooth flanks form torque transmission flanks 4, 4′, 5, 5′. The height of the teeth and the angle of inclination of the tooth flanks of the interengaging teeth of the toothing 23 define a limit torque. During the application of the torque and an increase of the torque, the oblique tooth flanks of the toothing 23 can slide on one another until they reach the position illustrated in FIG. 6, in which the teeth of the toothing 23 have been disengaged. The coupling projections 6 slide along the coupling projections 13, which have a sufficient axial length, during the concomitant axial displacement of the torque transmission body 3.1.

The torque exerted upon the output part 2 can no longer be increased once the position illustrated in FIG. 6 is reached. The input part 1 rotates relative to the output part 2. The torque limiting device between the first torque transmission body 3.1 and the second torque transmission body 3.2, which is located directly adjacent to the first torque transmission body 3.1, has a limit torque of 2 Nm. A torque limiting device between the second torque transmission body and a third torque transmission body 3.3 has a greater limit torque of 3 Nm. Consequently, the torque limiting device between the second torque transmission body 3.2 and the third torque transmission body 3.3 makes it possible to transmit a greater limit torque than the torque limiting device between the first torque transmission body 3.1 and the second torque transmission body 3.2. The third torque transmission body 3.3 borders on a fourth torque transmission body 3.4 with another torque limiting device. This torque limiting device makes it possible to transmit an additionally increased limit torque of 4 Nm. The fourth torque transmission body 3.4 borders on the driver 21 with another torque limiting device that makes it possible to transmit an additionally increased limit torque of 5 Nm. Consequently, the torque limiting devices between the spring element 17 and the driver 21 have an incrementally increasing limit torque.

The switching cam 16 is displaced into the latching recess 32.1 when a torque is applied in the clockwise direction. When a torque is applied in the counterclockwise direction, the switching cam 16 is displaced into the indentation 35 lying opposite of the latching recess 32.1. However, another latching recess may also be provided instead of the indentation 35. The latching recesses furthermore may be designed angularly such that the switching cams cannot move out of the latching recesses when the rotating direction is changed. The switching cams 16 may be interlocked in the handle in the form of a bayonet catch.

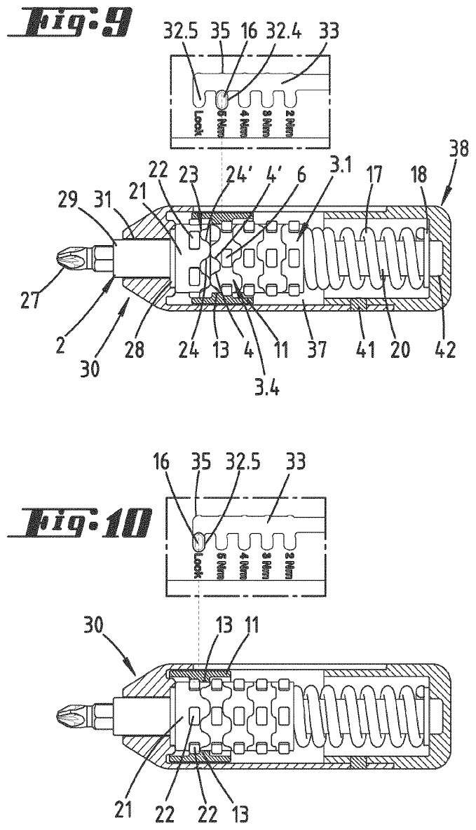

Once the switching cam 16 is removed from the latching recess 32.1, it can be moved into a different axial position in the longitudinal slots 33, e. g. into the position illustrated in FIGS. 7 and 8, in which the coupling projections 6 of a third torque transmission body 3.3 lie in the coupling recesses 12 such that the third torque transmission body 3.3 essentially is connected to the input part 2 in a rotationally fixed manner. The torque limiting devices between the third torque transmission body 3.3 and the first torque transmission body 3.2, as well as the torque limiting device between the second torque transmission body 3.2 and the first torque transmission body 3.1, have no function in this switching position. In this case, the torque is only transmitted by the torque limiting devices between the third torque transmission body 3.3 and the fourth torque transmission body 3.4 and between the fourth torque transmission body 3.4 and the driver 21.

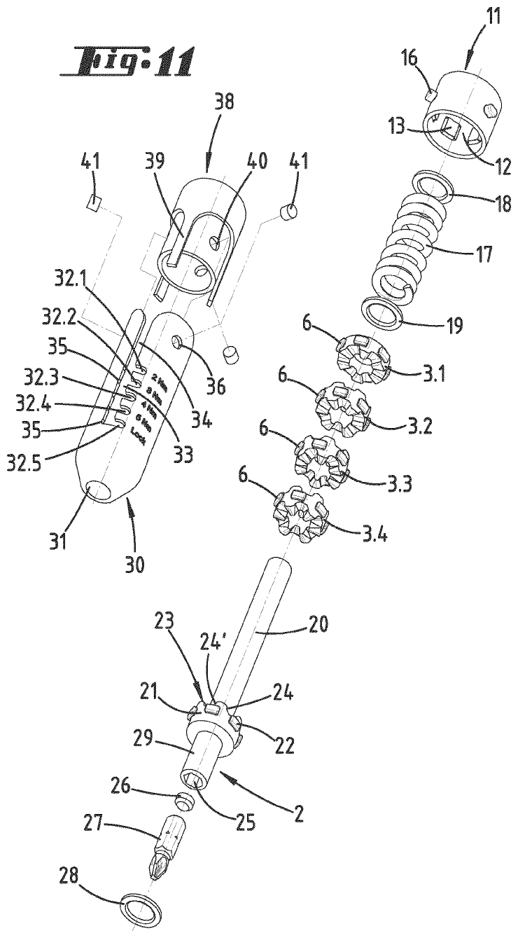

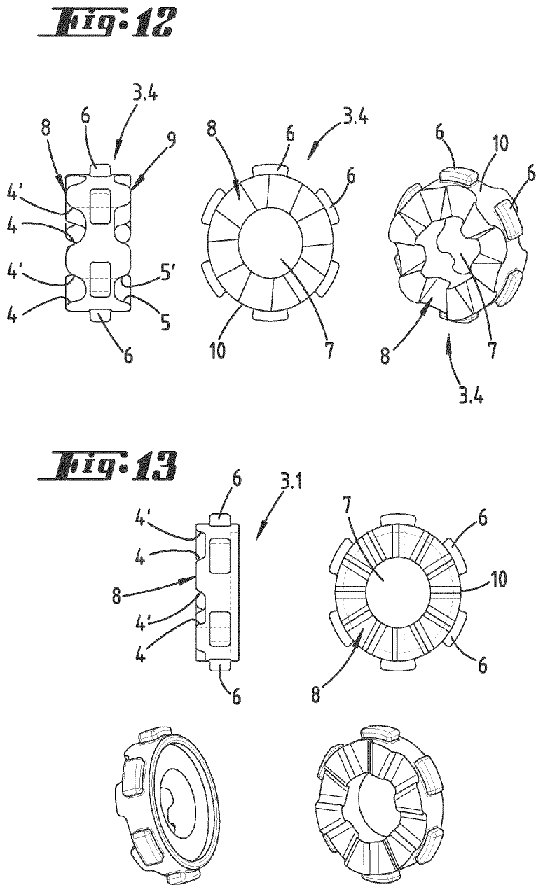

A further axial displacement of the switching member 11 makes it possible to reach the switching position illustrated in FIG. 9, in which the limit torque is defined solely by the torque limiting device between the fourth torque transmission body 3.4 and the driver 21.

An even further axial displacement of the switching member 11 makes it possible to reach the switching position illustrated in FIG. 10, in which the coupling projections 21 protruding from the driver 21 in the axial direction engage into the coupling recesses 12. The input part 1 is coupled to the output part 2 without a torque limiting device in this switching position.

It is considered to be advantageous that a single helical pressure spring 17, particularly a preloaded helical pressure spring, makes it possible to bring the device into different defined switching states, in which a defined maximum torque can be respectively transmitted.

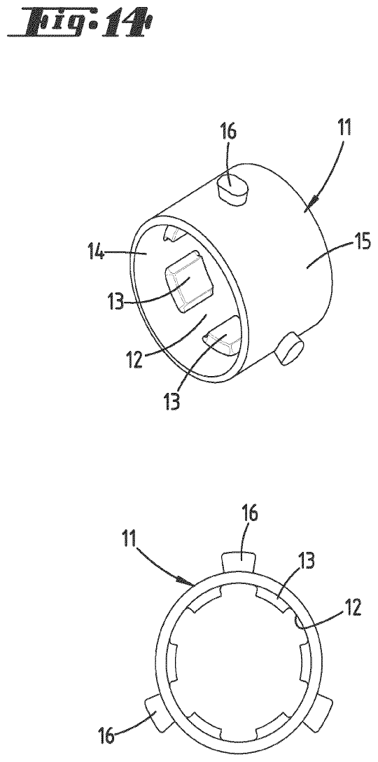

It is furthermore considered to be advantageous that the magnitude of the defined limit torques can be adjusted solely with the angles of inclination or the axial heights of the torque transmission flanks 4, 4′, 5, 5′ in combination with the preload of the spring element. FIGS. 12 and 13 show an example of the fourth torque transmission body 3.4, wherein the torque transmission flanks 4, 4′ of this fourth torque transmission body on the input side have the greatest axial length in FIG. 12. The torque transmission flanks 5, 5′ on the output side have a slightly shorter axial length. FIG. 13 shows the first torque transmission body 3.4, which has torque transmission flanks 4, 4′ with the shortest axial length on the output side only.

It is proposed that the respectively interengaging toothings 23 forming the torque transmission flanks 4, 4′, 5, 5′, 24, 24′ are realized identically such that a seamless tooth engagement without play is ensured.

The above-described technical advantages can also be achieved with another exemplary embodiment, in which one of multiple torque transmission bodies is selectively brought into an operative position by means of the switching member 11. In such an exemplary embodiment, each torque transmission body may have a torque limiting device with the output part 2 as it is basically known from the prior art. In contrast to the prior art, all torque limiting devices should be acted upon by the same spring in this case. For this purpose, it would be possible, for example, to respectively arrange driver between two adjacent torque transmission bodies, wherein said driver is connected to the [text missing], on which the torque transmission bodies are rotatably mounted, and forms torque transmission flanks that act in the axial direction. This can be achieved in that these additional drivers, which are axially connected to the output part 2 and can individually interact with a torque transmission body, can be axially displaced relative to the output part. For example, the drivers may be different disk-shaped bodies that are arranged between two torque transmission bodies and form torque transmission flanks on at least one side.

According to a not-shown variation of the invention, it is proposed that the shaft 20 has an external thread on at least its free end, wherein a nut can be screwed on said external thread, e.g. as described in DE 10 2004 016 521 A1, in order to thereby tension the spring 17. However, it would also be possible to provide other non-positive or positive connections for constraining the end of the spring element 17 pointing away from the torque transmission bodies 3 on the shaft 20 such that it is not supported in the housing, but rather on the shaft 20.

It would furthermore be possible that the switching member 11 is seated outside an inner housing sleeve, wherein this housing sleeve may be designed similar to the handle part 30 illustrated in the drawings. The housing sleeve may have a longitudinal slot 34, through which a coupling projection 13 of the switching member 11 can protrude. Multiple longitudinal slots 34 that are offset in the circumferential direction may be provided and a coupling projection 13, which interacts with the coupling projections 6 of the torque transmission bodies 3, respectively protrudes through said longitudinal slots.

It would also be possible that the coupling projections 13 or the switching cams 16 are guided in one or more longitudinal slots 34 in such a way that the switching member 11 does not move in the circumferential direction within the handle 30 when the rotating direction is reversed.

Latching elements can be provided for constraining the switching member 11 in the different axial positions, wherein said latching elements can be released, e.g. by actuating a pushbutton, in order to displace the switching member 11 in an axial direction.

In another not-shown exemplary embodiment, an outer handle sleeve may furthermore be provided, wherein said outer handle sleeve can be pushed over the switching member 11 or a handle part accommodating the switching member 11 such that the switching member 11 is in an operative position arranged within the outer sleeve-shaped handle part in a dustproof manner. An indicator displaying the currently adjusted torque may furthermore be provided. For this purpose, a handle sleeve may have a window, through which a slide or the switching member 11 is visible. The visible region of the slide or the switching member 11 then carries a reference number that indicates the magnitude of the adjusted torque.

The preceding explanations serve for elucidating all inventions that are included in this application and respectively enhance the prior art independently with at least the following combinations of characteristics, wherein two, multiple or all of these combinations of characteristics may also be combined with one another, namely:

A device, which is characterized by a switching member 11, by means of which the first and second torque transmission bodies 3.1, 3.2, 3.3, 3.4 can be selectively brought into one of the operative positions.

A device, which is characterized in that the at least two torque transmission bodies, which lie behind one another in an axial direction referred to a rotational axis of the device, are acted upon by a common spring element 17.

A device, which is characterized in that that the torque limiting devices are formed by torque transmission flanks 4, 4′, 5, 5′, 24, 24′ and the torque transmission flanks 4, 4′, 5, 5′, 24, 24′ of the torque transmission bodies 3.1, 3.2, 3.3, 3.4, which are directly stacked on top of one another, differ from one another in such a way that the limit torques of the torque limiting devices 4, 4′, 5, 5′, 24, 24′ increase incrementally, wherein this is realized, in particular, in that the torque transmission flanks of different torque limiting devices 3.1, 3.2, 3.3, 3.4 differ with respect to the angle of inclination of the torque transmission flanks 4, 4′, 5, 5′, 24, 24′ and/or with respect to the axial height of the torque transmission flanks 4, 41, 5, 5′, 24, 24′.

A device, which is characterized in that multiple torque transmission bodies 3.1, 3.2, 3.3, 3.4, which form the torque transmission flanks 4, 4′, 5, 5′, 24, 24′, are arranged axially behind one another in a cavity 37 of the input part 1 such that they are only coupled by means of a mutual tooth engagement and can axially yield against the restoring force of a spring element 17, wherein one of the torque transmission bodies 3.1, 3.2, 3.3, 3.4 can be selectively coupled to the input part 1 in a rotationally fixed manner by means of the switching member 11, and/or in that the first torque transmission body 3.1 is directly acted upon by the spring element 17 and the torque transmission flanks 4, 4′ of a last torque transmission body 3.4 interact with torque transmission flanks 24, 24′ of a driver 21 that is rigidly connected to the output part 2.

A device, which is characterized in that the torque transmission bodies 3.1, 3.2, 3.3, 3.4 have coupling projections 6 that are directed radially outward and engage into coupling recesses 21 of the switching member 11, which particularly is realized in the form of a sleeve, wherein the switching member 11 is arranged within the cavity 37 of the input part 1 in a displaceable manner and can be fixed in at least two different axial positions.

A device, which is characterized in that a driver 21, which is connected to the output part 2 in a rotationally fixed manner and coupled to a torque transmission body 3.1, 3.2, 3.3, 3.4 by means of a torque limiting device 4, 4′, 24, 24′, has coupling projections 22 that engage into coupling recesses 12 of the switching member 11 in one of its switching positions.

A device, which is characterized in that torques can be transmitted from the input part 1 to the output part 2 in the counterclockwise direction, as well as in the clockwise direction, in the different switching positions of the switching member 11, wherein the limit torques that can be transmitted in the counterclockwise direction and in the clockwise direction can differ from one another or be identical.

A device, which is characterized in that the switching member 11 has at least one radially protruding switching cam 16 that can engage into latching recesses 32.1, 32.2, 32.3, 32.4, 32.5, which particularly are arranged in a comb-like manner, in different switching positions of the switching member 11.

A device, which is characterized in that the output part 2 has a driver 21, which is connected to the output part in a rotationally fixed manner, and a shaft 20, wherein the driver 21 is supported on an end face of a cavity 37 of a handle 30, 38 formed by the input part 1 and the shaft 20 extends through a helical pressure spring 17 and is supported in an opposite end face of the cavity 37, and wherein a plurality of torque transmission bodies 3.1 to 3.4 are rotatably mounted on the shaft 20 between the driver 21 and the spring 17 and respectively coupled to an adjacent torque transmission body 3.1 to 3.4 or the driver 21 by means of a torque limiting device 4, 4′, 5, 5′, 24, 24′.

All disclosed characteristics are essential to the invention (individually, but also in combination with one another). The disclosure of the associated/attached priority documents (copy of the priority application) is hereby fully incorporated into the disclosure content of this application, namely also for the purpose of integrating characteristics of these documents into claims of the present application. The characteristics of the dependent claims also characterize independent inventive enhancements of the prior art without the characteristics of a claim to which they refer, particularly for submitting divisional applications on the basis of these claims. The invention specified in each claim may additionally comprise one or more of the characteristics that were disclosed in the preceding description and, in particular, are identified by reference symbols and/or included in the list of reference symbols. The invention also concerns design variations, in which individual characteristics cited in the preceding description are not realized, particularly as far as they are obviously dispensable for the respective intended use or can be replaced with other, identically acting technical means.

### LIST OF REFERENCE SYMBOLS

1 Input part
2 Output part
3.1 Torque transmission body
3.2 Torque transmission body
3.3 Torque transmission body
3.4 Torque transmission body
4 Torque transmission flank
4′ Torque transmission flank
5 Torque transmission flank
5′ Torque transmission flank
6 Coupling projection
7 Cavity
8 Toothing
9 Toothing
10 Circumferential surface
11 Switching member
12 Coupling recess
13 Coupling projection
14 Inner wall
15 Outer wall
16 Switching cam
17 Spring element
18 Washer
19 Washer
20 Shaft
21 Driver
22 Coupling projection
23 Toothing
24 Torque transmission flank
24′ Torque transmission flank
25 Insertion opening
26 Magnet
27 Screwdriver bit
28 Washer
29 Bearing section
30 Handle part
31 Bearing cavity
32.1 Latching recess
32.2 Latching recess
32.3 Latching recess
32.4 Latching recess
32.5 Latching recess
33 Longitudinal slot
34 Longitudinal slot
35 Indentation
36 Mounting opening
37 Cavity
38 Handle part
39 Ridge
40 Mounting opening
41 Connecting pin
42 Bearing depression
A Axis

1. A device comprising at least two torque transmission bodies (3.1, 3.2, 3.3, 3.4), which can be switched into different operative positions in a torque transmission path between an input part (1) and an output part (2) by means of a switching member (11), wherein the torque transmission bodies (3.1, 3.2, 3.3, 3.4) are assigned torque limiting devices (4, 4′; 5, 5′; 24, 24′), by means of which only torques below another limit torque can be transmitted in the different operative positions.

2. The device according to claim 1, wherein the at least two torque transmission bodies (3.1, 3.2, 3.3, 3.4) lie behind one another in an axial direction referred to a rotational axis of the device and are acted upon by a common spring element (17).

3. The device according to claim 2, wherein the torque limiting devices are formed by torque transmission flanks (4, 4′, 5, 5′, 24, 24′) and the torque transmission bodies (3.1, 3.2, 3.3, 3.4), which torque transmission flanks (4, 4′, 5, 5′, 24, 24′) are directly stacked on top of one another, and differ from one another in such a way that the limit torques of the torque limiting devices (4, 4′, 5, 5′, 24, 24′) increase incrementally in a direction of the output part (2) starting from a torque transmission body (3.1) that is axially spaced apart from the output part (2) by the greatest distance.

4. The device according to claim 3, wherein the torque transmission flanks of different torque limiting devices (3.1, 3.2, 3.3, 3.4) differ with respect to an angle of inclination of the torque transmission flanks (4, 4′, 5, 5′, 24, 24′) and/or with respect to an axial height of the torque transmission flanks (4, 4′, 5, 5′, 24, 24′).

5. The device according to claim 3, wherein multiple torque transmission bodies (3.1, 3.2, 3.3, 3.4), which form the torque transmission flanks (4, 4′, 5, 5′, 24, 24′), are arranged axially behind one another in a cavity (37) of the input part (1) such that the torque transmission bodies (3.1, 3.2, 3.3, 3.4) are only coupled to one another by means of a mutual engagement of the torque transmission flanks and can axially yield against a restoring force of a spring element (17), wherein one of the torque transmission bodies (3.1, 3.2, 3.3, 3.4) can be selectively coupled to the input part (1) in a rotationally fixed manner by means of the switching member (11).

6. The device according to claim 1, wherein a first torque transmission body (3.1) of the torque transmission bodies is directly acted upon by the spring element (17) and the torque transmission flanks (4, 4′) of a last torque transmission body (3.4) of the torque transmission bodies interact with torque transmission flanks (24, 24′) of a driver (21) that is rigidly connected to the output part (2).

7. The device according to claim 1, wherein the torque transmission bodies (3.1, 3.2, 3.3, 3.4) have coupling projections (6) that are directed radially outward and engage into coupling recesses (21) of the switching member (11), which is in the form of a sleeve, wherein the switching member (11) is arranged within the cavity (37) of the input part (1) in a displaceable manner and is configured to be fixed in at least two different axial positions.

8. The device according to claim 1, wherein a driver (21), which is connected to the output part (2) in a rotationally fixed manner and coupled to one of the torque transmission bodies (3.1, 3.2, 3.3, 3.4) by means of a torque limiting device (4, 4′, 24, 24′), has coupling projections (22) that engage into coupling recesses (12) of the switching member (11) in a switching position thereof.

9. The device according to claim 1, wherein the device is configured such that torques are transmittable from the input part (1) to the output part (2) in the counterclockwise direction, as well as in the clockwise direction, in the different switching positions of the switching member (11).

10. The device according to claim 9, wherein the limit torques, which are transmittable in the counterclockwise direction and in the clockwise direction, differ from one another or are identical.

11. The device according to claim 1, wherein the switching member (11) has at least one radially protruding switching cam (16) that is configured to engage into latching recesses (32.1, 32.2, 32.3, 32.4, 32.5), which are arranged in a comb-like manner, in different switching positions of the switching member (11).

12. The device according to claim 1, wherein the output part (2) has a driver (21), which is connected to the output part in a rotationally fixed manner, and a shaft (20), wherein the driver (21) is supported on an end face of a cavity (37) of a handle (30, 38) formed by the input part (1) and the shaft (20) extends through a helical pressure spring (17) and is supported in an opposite end face of the cavity (37), and wherein a plurality of torque transmission bodies (3.1 to 3.4) are rotatably mounted on the shaft (20) between the driver (21) and the spring (17) and respectively coupled to an adjacent torque transmission body (3.1 to 3.4) or the driver (21) by means of a torque limiting device (4, 4′, 5, 5′, 24, 24′).

13. The device according to claim 1, wherein a torque applied to the input part (1) is in a first operative position only transmitted to the output part (2) if the torque lies below a first limit torque and a torque applied to the input part (1) is in a second operative position only transmitted to the output part (2) if the torque lies below a second limit torque that is greater than the first limit torque, wherein the torque is in the first operative position transmitted by means of a first torque transmission body (3.3) and a second torque transmission body (3.4) of the two transmission bodies and the torque is in the second operative position only transmitted by means of the second torque transmission body (3.4).

14. The device according to claim 1, wherein only one torque transmission body (3.1, 3.2, 3.3, 3.4) is respectively connected to the input part (1) in a rotationally fixed manner in the different operative positions.

15. (canceled)
